(19) United States
(12) Patent Application Publication
(10) Pub. No.: US 2009/0073610 A1
(43) Pub. Date: Mar. 19, 2009

(54) Magnetic head slider and magnetic disk drive

(76) Inventors: Toshiaki Ohtani, Kanagawa (JP); Naotoshi Akamatsu, Kanagawa (JP); Hiroyuki Nakamura, Kanagawa (JP); Junguo Xu, Ibaraki (JP); Yuichi Aoki, Kanagawa (JP)

Correspondence Address: TOWNSEND AND TOWNSEND AND CREW LLP, TWO EMBARCADERO CENTER, 8TH FLOOR, SAN FRANCISCO, CA, 94111, US

(21) Appl. No.: 12/284,080

(22) Filed: Sep. 17, 2008

(30) Foreign Application Priority Data
Sep. 18, 2007 (JP) 2007-240736

(51) Int. Cl. G11B 5/60

(52) U.S. Cl. 360/234.3

(57) ABSTRACT

Embodiments of the present invention provide a magnetic head slider having a surface that is formed into a multiple step configuration to stabilize flying of the slider. According to one embodiment, a magnetic head slider has an air bearing surface including surfaces in three stages different in height from one another. An outflow side rail surface and inflow side rail surfaces, in a first stage are approximately the same in height. A rear step bearing surface, front step bearing surface, and side step bearing surfaces and, which are in a second stage, are shallow step surfaces being approximately the same in height, and being formed lower than the surfaces in the first stage. A deep cavity surface is formed further lower than the surfaces in the second stage. A film for preventing adhesion of organic contaminants and a lubricant is formed on the shallow step surfaces, and in the second stage.

### CROSS-REFERENCES TO RELATED APPLICATIONS

The instant nonprovisional patent application claims priority to Japanese Patent Application No. 2007-240736 filed Sep. 18, 2007 and which is incorporated by reference in its entirety herein for all purposes

### BACKGROUND OF THE INVENTION

In a magnetic disk drive, a magnetic head slider flies on a magnetic recording medium (magnetic disk) being rotated while keeping a constant space. Typically, the magnetic head slider has a magnetic transducer (magnetic head) for writing a signal into the magnetic disk, and for reading a signal on the magnetic disk at an air outflow end side. For the magnetic disk drive, reduction in distance between the magnetic disk and the magnetic head is required to reduce recording unit area (bit) so that recording capacity is increased. Therefore, flying, height of the magnetic head slider needs to be decreased, and furthermore, flying of the slider needs to be stabilized, and therefore a slider using negative pressure is generally used.

However, in the negative pressure slider, a negative pressure portion exists, which may cause a phenomenon that organic contaminant components in a housing is collected into the negative pressure portion of the magnetic head slider, or a phenomenon that a lubricant component on the magnetic disk is collected onto the magnetic head slider. When flying height is sufficiently high compared with a range of variation in flying attitude, such variation slightly affects the recording/reproducing operation of the magnetic head into/from the magnetic disk. However, since flying height is recently reduced, even if slight variation occurs in flying attitude of the slider, such variation may be problematic Therefore, even if only a small amount of organic contaminant components are absorbed into the negative pressure portion, variation in flying height occurs, which may affect the recording/reproducing operation. Moreover, when a lubricant is transferred onto the slider, the lubricant may be accumulated in a region where the negative pressure occurs, which may disturb a flying, attitude of the slider, or the accumulated lubricant sometimes falls onto the magnetic disk, and the slider collides with a droplet of the fallen lubricant, which may hinder stable flying of the slider.

Even in the CSS (Contract Start Stop) method in which when rotation of the magnetic disk is stopped, a magnetic head slider, which has flown on a magnetic disk, lands on the magnetic disk, a lubricant is accumulated on the magnetic head slider, and the lubricant enters into a space between the magnetic head slider and the magnetic disk when the rotation is stopped, so that the magnetic head slider adheres to the magnetic disk, leading to bad start. Therefore, a method is proposed as described in Japanese Patent Publication No. 11-353839, in which a surface of the magnetic head slider is coated with fluororesin so as to prevent accumulation of the lubricant onto the magnetic head slider.

In a magnetic disk drive in the same CSS method, when a magnetic head slider lands on a magnetic disk, water or an oil component may enter into the space between the magnetic head slider and the magnetic disk, causing an adhesion problem in the magnetic head slider. Therefore, measures are proposed as solutions of the problem as disclosed in Japanese Patent Publication No 59-227065, Japanese Patent Publication No. 61-87209. Japanese Patent Publication No. 63-251981, Japanese Patent Publication No. 8-102164, Japanese Patent Publication No. 4-102221, Japanese Patent Publication No. 5-325161. Japanese Patent Publication No. 6-259911, and Japanese Patent Publication No. 7-312051. These proposed measures prevent absorption of a problematic substance by surface treatment of the magnetic head slider using a fluoro compound.

As described above, as a measure for preventing accumulation of the organic contaminants or the lubricant onto the magnetic head slider, it is effective that a surface of the magnetic head slider is modified into a surface having low surface energy by coating a fluoro compound on the surface so as to prevent absorption or accumulation of the contaminants or the lubricant. However, in a perfluoropolyether series lubricant, which is typically used for a magnetic disk drive, since the lubricant itself is a fluoro compound, a water repellent or oil repellent effect is exhibited even on a magnetic disk surface coated with such a lubricant in a form of extremely thin film. Therefore, to prevent adhesion of such a lubricant, the surface of the magnetic head slider is required to be modified into a surface having further low surface energy compared with surface tension of the lubricant.

In the case that the surface of the magnetic head slider is coated with fluororesin, when the fluororesin coating exists even on a flying surface on which a magnetic transducer (magnetic head) exists, a distance between a magnetic head and a magnetic disk medium is increased by thickness of a coating film, leading to reduction in S/N during recording/reproducing, which prevents increase in recording capacity.

Therefore, if absorption of the organic contaminants or absorption of the lubricant can be inhibited without increasing the distance between the magnetic head and the magnetic disk medium, a reliable magnetic disk drive can be provided without preventing future increase in recording density. Moreover, in a recent magnetic head slider, a slider surface is formed in a multiple step configuration to stabilize flying of the slider. As a result, adhesion of the organic contaminants or accumulation of the lubricant occurs in a specific region, and therefore a measure for preventing the adhesion needs to be taken.

### BRIEF SUMMARY OF THE INVENTION

Embodiments of the present invention provide a magnetic head slider having a surface formed into a multiple step configuration to stabilize flying of the slider. According to the embodiment of FIG. 1, a magnetic head slider 1 has an air bearing surface 19 including surfaces in three stages different in height from one another. An outflow side rail surface 13 and inflow side rail surfaces 12a, 12b in a first stage are approximately the same in height. A rear step bearing surface 21, front step bearing surface 1, and side step bearing surfaces 22a and 22b, which are in a second stage, are shallow step surfaces being approximately the same in height, and being formed lower than the surfaces in the first stage. A deep cavity surface 10 is formed further lower than the surfaces in the second stage. A film 20 for preventing adhesion of organic contaminants and a lubricant is formed on the shallow step surfaces 11, 22a, 22b and 21 in the second stage.

### BRIEF DESCRIPTION OF THE DRAWINGS

FIG. 1 is a perspective diagram of a magnetic head slider according to an example of an embodiment of the invention.

FIG. 2 is a diagram of the magnetic head slider of FIG. 1 when the slider is seen from a side of an air outflow end face.

FIG. 3 is a plane diagram of a magnetic disk drive mounted with the magnetic head slider according to an embodiment of the invention.

FIG. 4 is a diagram showing a relationship between a contact angle of a lubricant and adhered amount of the lubricant on a film for preventing adhesion of organic contaminants and a lubricant in the magnetic head slider according to the example.

FIG. 5A is a perspective diagram showing a modification of the magnetic head slider according to the example.

FIG. 5B is a perspective diagram showing another modification of the magnetic head slider according to the example.

FIG. 6 is a partial side diagram showing still another modification of the magnetic head slider according to the example.

FIG. 7 is a plane diagram of a magnetic disk drive having a lubricant supply mechanism.

FIG. 8 is a diagram showing a manufacturing flow of the magnetic head slider according to the example.

FIG. 9 is a diagram showing a contact angle of a lubricant.

### DETAILED DESCRIPTION OF THE INVENTION

Embodiments of the present invention relate to a magnetic disk drive, and a magnetic head slider mounted on the magnetic disk drive or the like, in particular, embodiments of the invention help to prevent absorption/accumulation of a lubricant or organic contaminant components from a magnetic disk onto the magnetic head slider so as to secure flying stability of the magnetic head slider.

Embodiments of the invention were made in the light of the above problem, and an object of embodiments of the invention is to provide a magnetic head slider that can suppress absorption or accumulation of the lubricant or the organic contaminant components. In addition, another object of embodiments of the invention is to secure flying stability without increasing a distance between a magnetic head slider and a magnetic disk so as to provide a reliable magnetic disk drive.

To achieve the object, a magnetic head slider of embodiments of the invention may be characterized in that a film for preventing adhesion of organic contaminants and a lubricant is formed on a second stage surface from a flying surface of an air bearing surface formed on the flying surface, the air bearing surface including stepped surfaces in at least three stages.

For the film for preventing adhesion of organic contaminants and a lubricant, a compound containing fluorine is preferably used. As the compound containing fluorine, a fluororesin material including a polymer component containing one or at least two of fluoroacrylate, fluoromethacrylate, and fluoroethacrylate as a main raw material, or at least one of compound containing fluorine which bonded to a coating surface via siloxane bonds, or a material including one or at least two of polytetrafluoroethylene, tetrafluoroethylene-perfluoroalkylvinylether copolymer, tetrafluoroethylene-hexafluoropropylene copolymer, tetrafluoroethylene-ethylene copolymer, polyvinylidene fluoride, polychlorotrifluoroethylene, and chlorotrifluoroethylene-ethylene copolymer, or a carbon protective film containing fluorine is preferable.

Furthermore, the film for preventing adhesion of organic contaminants and a lubricant may be formed on not only the second stage surface from the flying surface, but also a third stage surface, or a surface in a fourth or later stage from the flying surface.

Furthermore, the film may be formed on both side faces of the magnetic head slider, or formed on both side faces and an outflow side end face, or formed on both side faces, the outflow side end face and the inflow side end face.

Furthermore, the film for preventing adhesion of organic contaminants and a lubricant may be formed on not only the second stage surface from the flying surface, but also a flying surface being the same in height as a flying surface on which a magnetic transducer exists.

Furthermore, the film for preventing adhesion of organic contaminants and a lubricant may be formed on the second stage surface from the flying surface, in addition, may be formed on a flying surface except for an area enclosed with an optional length of about 20 μm or less from the center of a magnetic transducer portion for recording and reproducing in circumferential and radial directions in flying of the magnetic head slider on the magnetic disk, in the flying surface on which the magnetic transducer exists.

Furthermore, the film for preventing adhesion of organic contaminants and a lubricant may be formed on not only the second stage surface from the flying surface, but also a flying surface except for an area enclosed with an optional length of about 20 μm or less in circumferential and radial directions with the center of lowest flying point in flying of the magnetic head slider on the magnetic disk.

To achieve the object, a magnetic disk drive of embodiments of the invention may be characterized by having a magnetic head slider mounted on the drive, in which a film for preventing adhesion of organic contaminants and a lubricant is formed on a second stage surface from a flying surface of an air bearing surface formed on the flying surface, the air bearing surface including stepped surfaces in at least three stages.

The magnetic disk drive desirably has a mechanism for supplying a lubricant onto a magnetic disk in the drive.

According to embodiments of the invention, absorption or accumulation of the lubricant or the organic contaminant components onto the magnetic head slider can be suppressed. Moreover, since stable flying of the magnetic head slider can be secured without increasing a distance between the magnetic head slider and the magnetic disk, a magnetic disk drive having high reliability can be obtained without causing reduction in S/N or reduction in recording capacity.

Hereinafter, embodiments of the invention will be described using drawings.

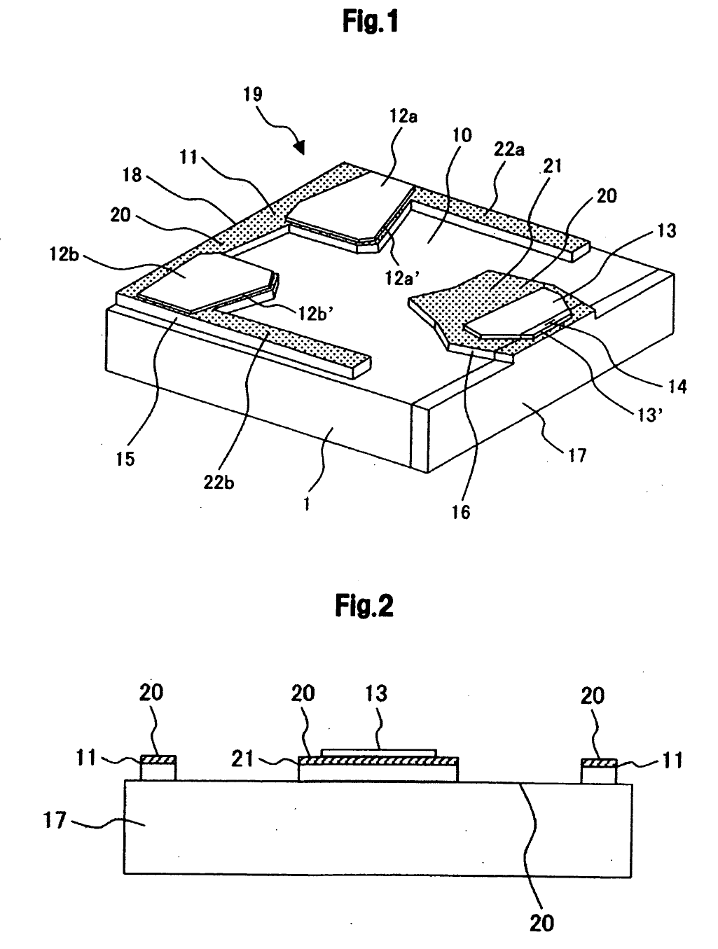

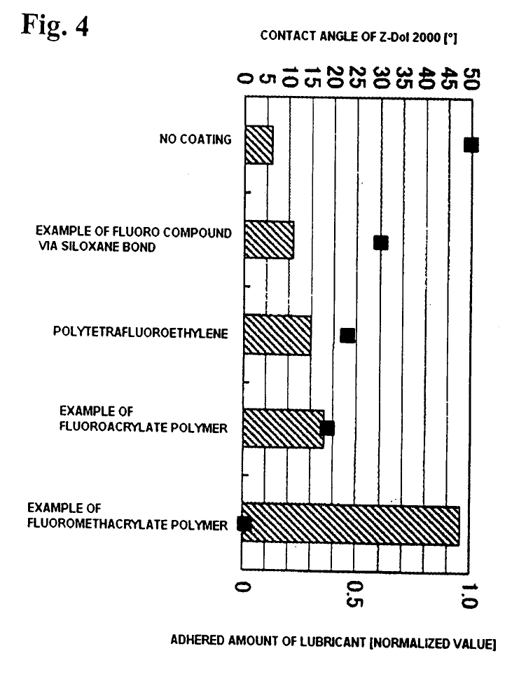

FIG. 3 shows a plane diagram of a magnetic disk drive on which a magnetic head slider according to the invention is mounted. The magnetic disk drive has a housing 3, a spindle motor 9 attached to the housing 3, a pivot 6, and a positioning mechanism 5. A hub of the spindle motor 9 is fixed with a magnetic recording medium (magnetic disk) 2 for recording information, and the magnetic disk 2 is rotated by the spindle motor 9. The pivot 6 is attached with a head support mechanism 40 including a suspension 4, and the suspension 4 is attached with a magnetic head slider 1 having a magnetic transducer 14 (refer to FIG. 1) for magnetically writing information onto the magnetic disk 2, or for reading magnetic information recorded on the disk. It is structured that a voice coil motor configuring the positioning mechanism 5 swings the magnetic head slider 1 with the pivot 6 as an axis, so that the slider 1 can perform seek on the magnetic disk 2. The magnetic head slider 1 has an air bearing surface (ABS) formed on a flying surface being a surface opposed to the magnetic disk 2, and flies on a rotating magnetic disk 2 while keeping a slight gap. It is structured that when rotation of the magnetic disk 2 is stopped, the magnetic head slider 1 and the suspension 4 can be withdrawn from a place on the magnetic disk 2. A dust filter 8 for removing dust is provided in the housing 3.

Here, the magnetic disk 2 is not limited to be in an in-plane recording method or a perpendicular recording method, and it is enough that information can be written or read into/from the magnetic disk 2 by the magnetic transducer 14 on the magnetic head slider 1. Moreover, the magnetic disk 2 placed in the housing may include a plurality of disks, and may be structured such that information can be recorded onto one side or both sides of the disk 2. A surface of the magnetic disk 2 is coated with the perfluoropolyether series lubricant.

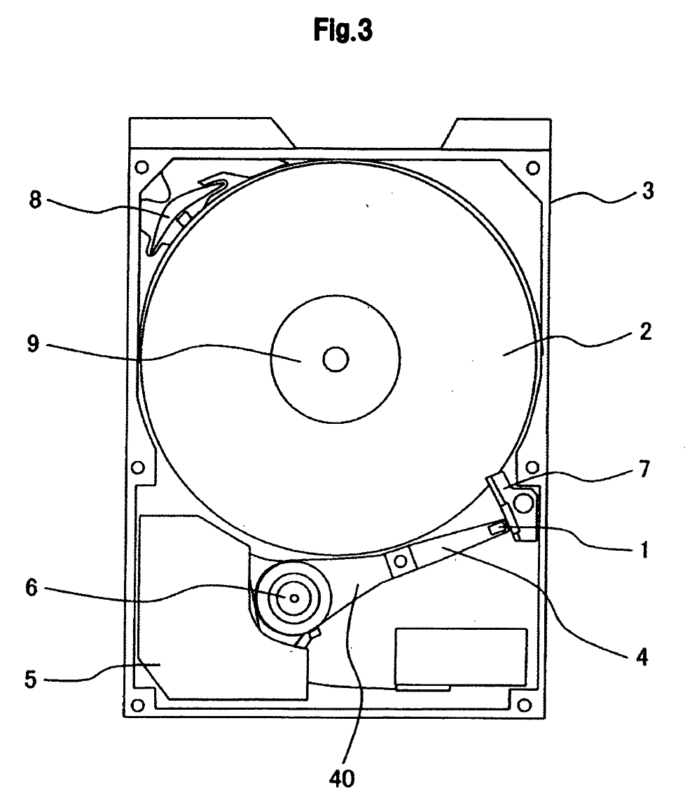

Next, detailed description is made on a magnetic head slider according to an example to be mounted on the magnetic disk drive. FIGS. 1 and 2 show the magnetic head slider according to the example, wherein FIG. 1 shows a perspective diagram seen from a flying surface side, and FIG. 2 shows a diagram seen from an air outflow end side. In the magnetic head slider 1, an air-bearing surface 19 for stably flying on the magnetic disk 2 is formed on a surface (flying surface) opposed to the magnetic disk 2. The air-bearing surface 19 is configured by surfaces in three stages different in height from one another. A front pad 15 at an air inflow end 18 and a rear pad 16 at an air outflow end 17 are formed via a deep cavity surface 10. The front pad 15 is configured by inflow side rail surfaces 12a, 12b forming a first stage surface, and a front step bearing surface 11 and side step bearing surfaces 22a, 22b forming a second stage surface. The rear pad 16 is configured by an outflow side rail surface 13 forming a first stage surface, and a rear step bearing surface 21 to be a second stage surface. A third stage surface corresponds to the deep cavity surface 10. The outflow side rail surface 13 and the inflow side rail surfaces 12a, 12b are approximately the same in height, and are most proximate to the magnetic disk 2 when the flying surface faces the magnetic disk 2. The rear step bearing surface 21, front step bearing surface 11, and side step bearing surfaces 22a, 22b are approximately the same in height, and formed about 100 nm to 200 nm lower than the first stage surface. The step bearing surfaces forming the second stage surface are called shallow step surfaces. The deep cavity surface 10 is formed about 2 μm lower than the first stage surface. An inflowing air stream from an inflow end face side is controlled by such a configuration of the air bearing surface formed on the flying surface, so that the magnetic head slider 1 can stably fly on the magnetic disk 2.

However, when organic contaminants exist in the magnetic disk drive, the organic contaminants tend to be accumulated on rear ends 12a′, 12b′ at an air outflow side of the inflow side rail surfaces 12a, 12b, or on a rear end 13′ at an air outflow side of the outflow side rail surface 13. The contaminants in the magnetic disk drive mainly include a silicone-based organic gas. Moreover, a lubricant coated on a surface of the magnetic disk 2 tends to be transferred onto the magnetic head slider 1 due to negative pressure on the magnetic head slider 1, and accumulated on the rear ends 12a′, 12b′ at the air outflow side of the inflow side rail surfaces 12a, 12b, or on the rear end 13′ at the air outflow side of the outflow side rail surface 13.

In the example, to suppress such adhesion or accumulation of the organic contaminants or the lubricant onto the magnetic head slider 1, a film 20 for preventing adhesion of organic contaminants and a lubricant is formed on each of the shallow step surfaces 11, 22a, 22b and 21 in a second stage from a flying surface side as shown in FIGS. 1 and 2. Particularly, the film 20 is effectively formed on the shallow step surface 11 in regions where the rear ends 12a′, 12b′ at the air outflow side of the inflow side rail surfaces 12a, 12b are situated, and on the shallow step surface 21 in a region where the rear end 13′ at the air outflow side of the outflow side rail surface 13 is situated. The film 20 for preventing adhesion of organic contaminants and a lubricant suppresses adhesion of the organic contaminants and the lubricant onto the magnetic head slider 1, consequently they are not accumulated too much to disturb flying attitude of the magnetic head slider 1. Moreover, in the magnetic disk drive having the magnetic head slider 1 mounted thereon, since flying of the magnetic head slider 1 is stabilized, a reliable magnetic disk drive can be achieved.

In the example, the air bearing surface 19 is configured by surfaces in three stages different in height from one another. However, the number of stages is not limited to three, and may be four or more. In such a case, the film for preventing adhesion of organic contaminants and a lubricant needs to be formed on at least a second stage surface, and the film is desirably formed on all surfaces except for a first stage surface.

For the film 20 for preventing adhesion of organic contaminants and a lubricant, a compound containing fluorine is preferably used. As the compound containing fluorine, a fluororesin material including a polymer component containing one or at least two of fluoroacrylate, fluoromethacrylate, and fluoroethacrylate as a main raw material, or at least one of compound containing fluorine which bonded to the shallow step surface via siloxane bonds, or a material including one or at least two of polytetrafluoroethylene, tetrafluoroethylene-perfluoroalkylvinylether copolymer, tetrafluoroethylene-hexafluoropropylene copolymer, tetrafluoroethylene-ethylene copolymer, polyvinylidene fluoride, polychlorotrifluoroethylene, and chlorotrifluoroethylene-ethylene copolymer is preferable. Alternatively, a carbon protective film containing fluorine is preferably used for the film 20.

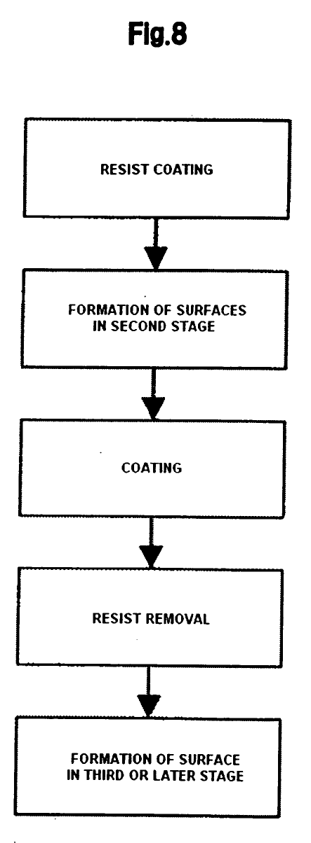

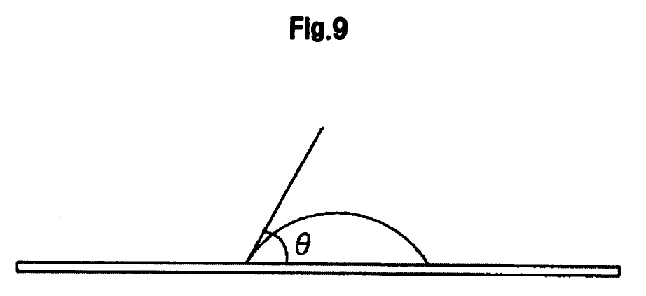

As a method of forming the film 20 for preventing adhesion of organic contaminants and a lubricant, it is desirable that the film is formed in desired portions by masking a surface except for regions to be coated. Specifically, a method is optimum, in which a resist used for forming the air bearing surface is further used for masking as above. The air bearing surface, which has surfaces different in height from one another, formed on the flying surface is formed by scraping portions except for regions protected using the resist by ion milling or RIE (Reactive Ion Etching). That is, as shown in FIG. 8, it is desirable that in a condition that the second stage surfaces (shallow step surfaces) have been formed by ion milling or RIE, the film 20 for preventing adhesion of organic contaminants and a lubricant is formed with the resist being left. Alternatively, it is acceptable that after the air bearing surface is formed, a resist film is formed again on a surface except for the shallow step surfaces, so that the film 20 for preventing adhesion of organic contaminants and a lubricant is formed.

As the method of forming the film 20 for preventing adhesion of organic contaminants and a lubricant, a method of forming the film by a dip coating method using a solution, in which a coating polymer component is dissolved, is preferable since film thickness is improved in uniformity. However, the film may be formed by a spray method, an inkjet method, or a dispenser method. Alternatively, the film may be formed by a sputter method rather than using a polymer solution. Alternatively, a carbon protective film containing fluorine may be formed by plasma polymerization as the film 20.

Verification was made on an effect of each of various kinds of films for preventing adhesion of organic contaminants and a lubricant used in the example by an accelerated evaluation test.

A silicone rubber adhesive having a component that emits a silicone-based organic gas was placed in a housing of a magnetic disk drive, and the magnetic disk drive was continuously operated at a high temperature of 60° C. In a magnetic disk drive in which the film for preventing adhesion of organic contaminants and a lubricant was not formed on a magnetic head slider, an error occurred after 108 hours had passed, and production of smear was confirmed on the magnetic head slider from a result of tear down analysis.

When an accelerated evaluation test was performed at the same accelerated test condition using the magnetic head slider 1 according to the example in which fluoroacrylic polymer film was formed by a dip coating method as the film 20 for preventing adhesion of organic contaminants and a lubricant, no error was found even after performing the accelerated test for 1000 hours. Furthermore, smear was not found on the magnetic head slider from a result of tear down analysis.

From the above, it was confirmed that when the film 20 for preventing adhesion of organic contaminants and a lubricant was formed on the shallow step surfaces 11, 22a, 22b and 21, resistance to the organic contaminants and lubricant was improved. For the resistance to the organic contaminants and lubricant, it is enough that the shallow step surfaces are modified into surfaces that hardly absorb the organic contaminants and the lubricant. Therefore, the same effect can be obtained even by a film formed by a different manufacturing method, or even by using resin containing fluorine other than the fluoroacrylic polymer.

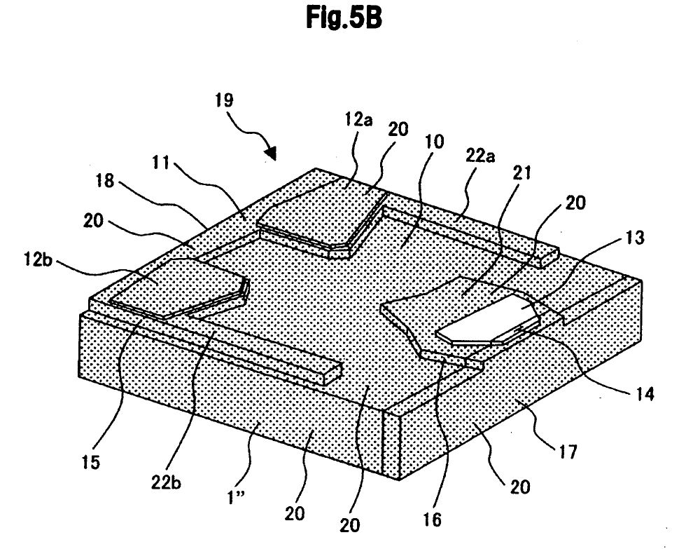

FIGS. 5A and 5B show modifications of the magnetic head slider 1 according to the example respectively. In FIG. 5A, the film 20 for preventing adhesion of organic contaminants and a lubricant is further formed on the deep cavity surface 10 being the third stage surface and side face portions unlike the above example. Furthermore, in FIG. 5B, the film 20 for preventing adhesion of organic contaminants and a lubricant is formed even on the inflow side rail surfaces 12a and 12b. As described in the example, a trouble caused by adhesion of the organic contaminants can be suppressed by the film 20 for preventing adhesion of organic contaminants and a lubricant formed on the shallow step surfaces 11, 22a, 22b and 21. Regarding transfer of the lubricant on the magnetic disk 2 onto the magnetic head slider 1, it is supposed that accumulation occurs from rear ends at air outflow sides of the inflow side rail surfaces 12a, 12b and from a rear end at an air outflow side of the outflow side rail surface 13, like the trouble due to the organic contaminants. Moreover, regarding the transfer of the lubricant onto the magnetic head slider 1, when a large amount of lubricant is transferred, the lubricant is further moved to and accumulated onto the deep cavity surface 10 being the third stage from the rear ends of the rail surfaces. Furthermore, the lubricant is accumulated in a region where air velocity is decreased to approximately zero by an air stream generated by the deep cavity surface 10. Such an accumulated lubricant gradually flows to the outflow end side, and eventually the lubricant is largely accumulated at the outflow end side of the air bearing surface. Particularly, alumina is deposited at the outflow end side in formation of a magnetic transducer 14, and since an etching rate of ion milling or RIE (Reactive Ion Etching), which is used in forming the deep cavity surface 10 during a formation process of the air bearing surface, is different between alumina (Al₂O₃) and a base material portion of the slider (AlTiC: Al₂O₃-TiC), a slight step is formed. Therefore, the lubricant is accumulated on the stepped portion between the alumina and the base material of the slider, and when the accumulated amount is increased, the lubricant may fall onto the magnetic disk 2, or may form a meniscus between the magnetic disk 2 and the magnetic head slider 1, causing disturbance of flying attitude of the magnetic head slider 1.

Therefore, the deep cavity surface 10 being the third surface on which the lubricant is accumulated is covered with the film 20 for preventing adhesion of organic contaminants and a lubricant, thereby adhesion of the lubricant can be further inhibited. That is, adhesion at the rear ends 12a′, 12b′ at the air outflow sides of the inflow side rail surfaces 12a, 12b, and adhesion at the rear end 13′ at the air outflow side of the outflow side rail surface 13, in which the accumulation is started at the initial stage are suppressed, and furthermore, even if accumulation is started, accumulation of the lubricant on the deep cavity surface 10 can be prevented, and consequently trouble due to transfer of the lubricant on the magnetic disk 2 can be prevented.

Even if the film 20 for preventing adhesion of organic contaminants and a lubricant is formed on the deep cavity surface 10, when the lubricant is transferred onto the magnetic head slider 1, the lubricant flows to the outflow end side due to an air stream on the deep cavity surface 10. When the lubricant reaches an outflow end face or each side face of the magnetic head slider 1, since aggregation of the lubricant may occur in the relevant surface, the film 20 for preventing adhesion of organic contaminants and a lubricant is preferably formed on both side faces, outflow end face, and inflow end face of the magnetic head slider 1′ as shown in FIG. 5A. However, even if the film is formed on both side faces and the outflow end face, or formed on both side faces and the inflow end face, a certain effect can be obtained.

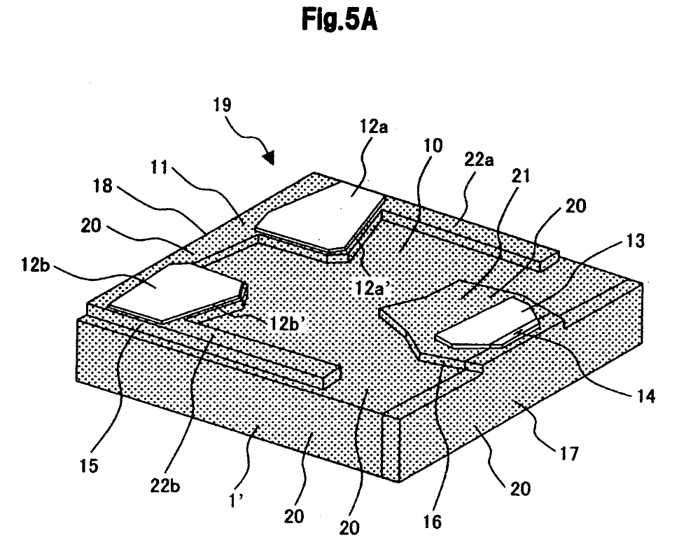

Using the magnetic head slider 1′ as shown in FIG. 5A, verification was made on the effect of each of the various kinds of films for preventing adhesion of organic contaminants and a lubricant by the accelerated evaluation test. As a result, a large effect was confirmed to be obtained by the fluoromethacrylate polymer. To verify a correlation between the result and a surface condition of the film for preventing adhesion of organic contaminants and a lubricant, a correlation between a contact angle of a lubricant on the film for preventing adhesion of organic contaminants and a lubricant, and a kind of the film was obtained as shown in FIG. 4. The contact angle described herein means an angle (θ) formed by a tangent of a droplet, which is formed when a liquid is dropped on a plane, and the plane at an intersection between the droplet and the plane. As the lubricant, Z-DOL (average molecular weight of 2000) manufactured by Solvay Solexis S.p.A. was used. Since an area having the coating is narrow in a surface of an actual magnetic head slider, the contact angle is hard to be measured on the surface. Therefore, the contact angle was measured using a surface on which a film in the same condition was formed on the same material as that of the magnetic head slider. A film for preventing adhesion of organic contaminants and a lubricant was formed on a base of Al₂O₃—TiC 10 mm in width, which was the same material as that of the magnetic head slider, then 1 μl of Z-DOL (average molecular weight of 2000) was dropped onto the film After 1 min had passed from the dropping, the contact angle was measured. Moreover, a magnetic head slider 1′ having a film for preventing adhesion of organic contaminants and a lubricant, which was prepared at the same processing condition, was allowed to fly on a magnetic disk, thereby an effect of the film was verified. Regarding the transfer amount of the lubricant, a surface of the magnetic head slider 1′ after the accelerated test was observed by a microscope, and the transfer amount was estimated from area of droplets adhered to the surface.

From the evaluation result, an effect of inhibiting absorption of a lubricant was confirmed when a film 20 for preventing adhesion of organic contaminants and a lubricant, which increases the contact angle of the lubricant to 10° or more, was formed. Moreover, it was confirmed that when the contact angle was 40° or more, the lubricant was substantially not adhered, showing a large effect of inhibiting absorption of a lubricant.

When the magnetic head slider 1′ flies on the magnetic disk 2, a distance between a portion of the magnetic transducer 14 and a recording layer on the magnetic disk 2 is a determination factor of S/N or recording density. Increase in the distance leads to reduction in S/N or reduction in recording density. Therefore, when the film 20 for preventing adhesion of organic contaminants and a lubricant is formed on the portion of the magnetic transducer 14, the distance between the portion of the magnetic transducer 14 and the recording layer on the magnetic disk 2 is increased, which is not preferable because increase in recording density is obstructed. On the other hand, if the film for preventing adhesion of organic contaminants and a lubricant is not formed on the portion of the magnetic transducer 14, no influence is exercised on write and read of a signal into/from the magnetic disk 2 by the magnetic transducer 14. In the light of this, the film 20 for preventing adhesion of organic contaminants and a lubricant is further formed on the inflow side rail surfaces 12a and 12b in FIG. 5B. It will be appreciated that the effect of inhibiting absorption of a lubricant is obtained even in the magnetic head slider 1 as in the magnetic head slider 1′ of FIG. 5A.

Material of the film 20 for preventing adhesion of organic contaminants and a lubricant used for each of the magnetic head sliders 1 and 1″ as shown in FIGS. 5A and 5B is the same as the material used in the example as shown in FIG. 1.

The film 20 for preventing adhesion of organic contaminants and a lubricant is desirably formed by a method where regions except for regions to be coated are masked, thereby the film is formed only on desired portions. In the case of the magnetic head slider 1′ or 1″, taking into consideration that the film 20 for preventing adhesion of organic contaminants and a lubricant is formed even on the side face portions, the magnetic head slider 1′ or 1″ is preferably coated after the slider is cut into a chip. Specifically, a method may be used, in which in a condition that the magnetic head slider 1′ or 1″ is cut into a chip, regions except for regions, on which the film 20 for preventing adhesion of organic contaminants and a lubricant is to be formed, are coated by a resist, then the film 20 for preventing adhesion of organic contaminants and a lubricant is formed.

As the method of forming the film 20 for preventing adhesion of organic contaminants and a lubricant, as in the above example, a method of forming the film by a dip coating method using a solution, in which a coating polymer component is dissolved, may be used since film thickness is improved in uniformity. However, the film may be formed by the spray method, inkjet method, or dispenser method. Alternatively, the film may be formed by a sputter method rather than using a polymer solution. Alternatively, a carbon protective film containing fluorine may be formed by plasma polymerization as the film 20.

In manufacturing of the magnetic head slider 1′ or 1″ as shown in FIG. 5A or 5B, a method may be used, in which a flat plate is closely adhered to a rail surface being not coated with the film 20 for preventing adhesion of organic contaminants and a lubricant, so that the film 20 for preventing adhesion of organic contaminants and a lubricant is formed on regions except for the rail surfaces. In this case, as a method of forming the film 20 for preventing adhesion of organic contaminants and a lubricant, a method is used, in which a solution having the coating polymer component dissolved therein is poured into a space between the flat plate and the magnetic head slider 1′ or 1″. Alternatively, a dip coating method, or a dispenser method may be used.

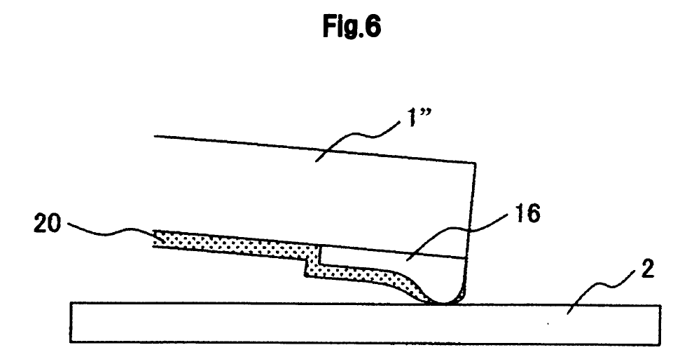

FIG. 6 shows a modification of the magnetic head slider 1″ shown in FIG. 5B. It was described using FIG. 5A that if the film 20 for preventing adhesion of organic contaminants and a lubricant did not exist on the magnetic transducer 14, reduction in S/N or reduction in recording density was not affectedly caused. In the light of this, after manufacturing the magnetic head slider, or in a state of HGA (Head Gimbals Assembly) where the head is attached to the suspension via gimbals, or in a state where HGA is attached to an arm, the film 20 for preventing adhesion of organic contaminants and a lubricant is formed by the dip coating method, then the film 20 for preventing adhesion of organic contaminants and a lubricant on the magnetic transducer 14 is worn out to be removed.

Specifically, a heater embedded in a portion near the magnetic transducer, which is a recent mechanism for flying height control of a magnetic head slider, is applied with a current, thereby a portion of the magnetic transducer can be protruded to a magnetic disk side. Using such a flying height control mechanism, the film 20 for preventing adhesion of organic contaminants and a lubricant is formed by the dip coating method using a fluoroacrylic polymer solution in the state of HGA, then a portion near the magnetic transducer on the magnetic head slider 1 is contacted to a rotating magnetic disk 2, so that the film 20 for preventing adhesion of organic contaminants and a lubricant is worn out to be removed. An area to be removed is a region except for an area enclosed with an optional length of about 20 μm or less from the center of the magnetic transducer 14. Alternatively, the area is a region except for an area enclosed with an optional length of about 20 μm or less with the center of lowest flying point in flying of the slider on the magnetic disk.

Even in the magnetic head slider, the effect of inhibiting adhesion of a lubricant and resistance to contaminants are the same as in the case as shown in FIG. 5B. For a wearing method, a method may be used, in which the flying height control mechanism is used to allow the film to contact to the magnetic disk 2 so as to be worn out. However, a method may be used, in which rotation number of the magnetic disk 2 is decreased, so that flying height of the magnetic head slider 1″ is reduced, thereby the film is allowed to contact to the magnetic disk. Alternatively, a method may be used, in which flying height of the magnetic head slider 1″ is reduced by decompression, thereby the film is allowed to contact to the magnetic disk. Furthermore, since it is enough that the film 20 for preventing adhesion of organic contaminants and a lubricant is not formed only in a region near the magnetic transducer 14, a method may be used, in which while a region on the magnetic transducer 14 is beforehand masked by a resist during manufacturing the magnetic head slider, the film 20 for preventing adhesion of organic contaminants and a lubricant is formed in other regions.

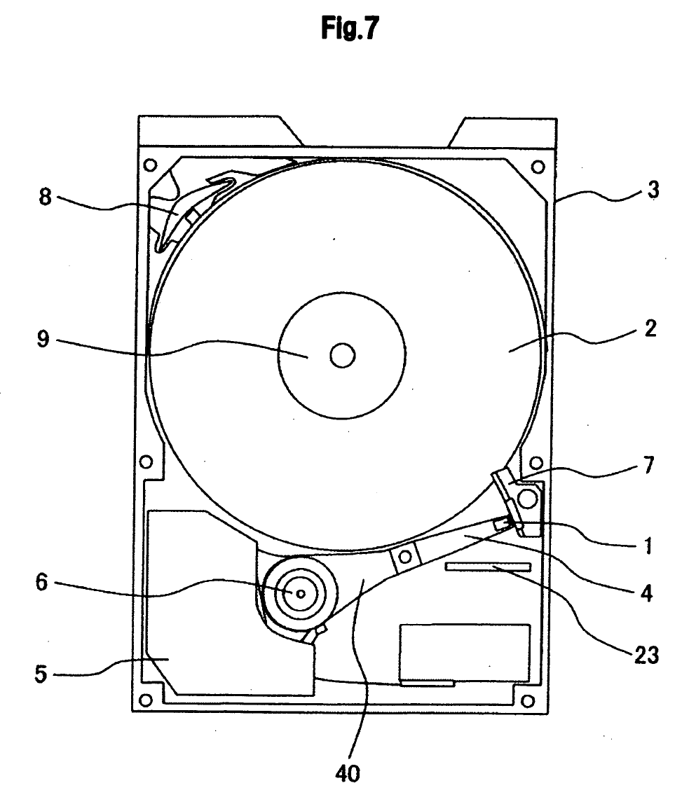

FIG. 7 shows a diagram showing an example that the magnetic head slider according to the example or the modification is mounted on a magnetic disk drive having a lubricant supply mechanism. It is known that the amount of the lubricant on the magnetic disk 2 is decreased due to spinning-off by rotation, contact to the magnetic head slider 1 or the like. It is proposed that a lubricant supply mechanism 23 is provided in the magnetic disk drive to compensate for such decrease in lubricant. The lubricant supply mechanism 23 is configured by a nonwoven fabric impregnated with the lubricant. However, when the lubricant is supplied, thickness of a lubricant film on the magnetic disk 2 is increased compared with initial thickness. As a result, the lubricant may be transferred onto the magnetic head slider 1. However, in the magnetic head slider 1, 1′ or 1″ according to the example or the modification, since transfer of the lubricant onto the magnetic head slider can be suppressed so as to prevent accumulation of the lubricant, when the lubricant supply mechanism 23 is used, if the magnetic head slider 1, 1′ or 1″ according to the example or the modification is used, stable flying of the magnetic head slider can be achieved, consequently a reliable magnetic disk drive can be achieved.

Effectiveness of embodiments of the invention was verified using the method in which the nonwoven fabric impregnated with the lubricant was provided in the magnetic disk drive, thereby the lubricant is supplied onto the magnetic disk 2 via a gas phase.

A magnetic head slider according to the example or the modification, in which the film for preventing adhesion of organic contaminants and a lubricant was formed using a fluoromethacrylic polymer, was compared to a magnetic head slider in which the film for preventing adhesion of organic contaminants and a lubricant was not formed. As a result, while a large amount of lubricant was accumulated in a specific region of the deep cavity surface in the magnetic head slider in which the film for preventing adhesion of organic contaminants and a lubricant was not formed, adhesion of the lubricant was not found on any of the deep cavity surface, side faces, and outflow end in the magnetic head slider according to the example or the modification, and accumulation of the lubricant was substantially not confirmed.

In this way, the magnetic disk drive having the lubricant supply mechanism can be further improved in reliability by being mounted with the magnetic head slider according to the example or the modification.

As described hereinbefore, according to the magnetic head slider according to the example or the modification, absorption or accumulation of the lubricant or the organic contaminant components onto the magnetic head slider can be suppressed. Moreover, according to the magnetic disk drive having the magnetic head slider mounted thereon, stable flying of the magnetic head slider can be secured without increasing a distance between the magnetic head slider and the magnetic disk, therefore reliability can be improved without causing reduction in S/N or reduction in recording capacity. Furthermore, in the magnetic disk drive having the lubricant supply mechanism, transfer and accumulation of the lubricant onto the magnetic head slider, which is problematic when the lubricant is excessively supplied, can be suppressed.

What is claimed is:

1. A magnetic head slider having
an air bearing surface, and
a magnetic transducer, characterized in that:
the air bearing surface is configured by surfaces in at least three stages different in height from one another, and
a film for preventing adhesion of organic contaminants and a lubricant is provided on a second stage surface from a side of highest surfaces of the air bearing surface.

2. The magnetic head slider according to claim 1, characterized by further having:
the film for preventing adhesion of organic contaminants and a lubricant on a surface in a third or later stage from the side of the highest surfaces of the air bearing surface.

3. The magnetic head slider according to claim 2, characterized by further having:
the film for preventing adhesion of organic contaminants and a lubricant on both side laces and an outflow side end face, or on both side faces, an inflow side end face, and the outflow side end face.

4. The magnetic head slider according to claim 1, characterized in that:
the magnetic transducer exists on a surface at an outflow side among the highest surfaces of the air bearing surface, and
the film for preventing adhesion of organic contaminants and a lubricant is provided on a surface being different from the surface, on which the magnetic transducer exists, but the same in height as the surface, and on both side faces and an outflow side end face, or provided on the different surface, and both side faces, an inflow side end face, and the outflow side end face.

5. The magnetic head slider according to claim 4, characterized by further having:
the film for preventing adhesion of organic contaminants and a lubricant in a region in the surface on which the magnetic transducer exists, the region except for an area enclosed with an optional length of about 20 μm or less from the center of the magnetic transducer.

6. The magnetic head slider according to claim 4, characterized by having:
the film for preventing adhesion of organic contaminants and a lubricant in a region except for an area enclosed with an optional length of about 20 μm or less with a center of lowest flying point in flying of the magnetic head slider on a magnetic disk.

7. The magnetic head slider according to claim 1, characterized in that:
the film for preventing adhesion of organic contaminants and a lubricant includes a compound containing fluorine.

8. The magnetic head slider according to claim 1, characterized in that:
the film for preventing adhesion of organic contaminants and a lubricant includes a fluororesin material including a polymer made from at least one of fluoroacrylate, fluoromethacrylate, and fluoroethacrylate as a main raw material.

9. The magnetic head slider according to claim 1, characterized in that:
the film for preventing adhesion of organic contaminants and a lubricant includes at least one of compound containing fluorine which bonded to the surface in the second stage via siloxane bonds.

10. The magnetic head slider according to claim 1, characterized in that:
the film for preventing adhesion of organic contaminants and a lubricant includes a carbon film containing fluorine.

11. The magnetic head slider according to claim 1, characterized in that:
the film for preventing adhesion of organic contaminants and a lubricant includes one or at least two of polytetrafluoroethylene, tetrafluoroethylene-perfluoroalkylvinylether copolymer, tetrafluoroethylene-hexafluoropropylene copolymer, tetrafluoroethylene-ethylene copolymer, polyvinylidene fluoride, polychlorotrifluoroethylene, and chlorotrifluoroethylene-ethylene copolymer.

12. A magnetic head slider having:
an air bearing surface, and
a magnetic transducer, characterized in that:
the air bearing surface is configured by an outflow side pad on which the magnetic transducer exists, an inflow side pad, a shallow step surface being one stage lower than the outflow-side and inflow-side pads, and a deep cavity surface lower than the shallow step surface, and
a film for preventing adhesion of organic contaminants and a lubricant is provided on the shallow step surface.

13. The magnetic head slider according to claim 12, characterized by further having:
the film for preventing adhesion of organic contaminants and a lubricant on the deep cavity surface.

14. The magnetic head slider according to claim 12, characterized in that:
the film for preventing adhesion of organic contaminants and a lubricant includes a compound containing fluorine.

15. A magnetic disk drive having
a magnetic disk for recording magnetic information.
a motor that rotationally drives the magnetic disk.
a magnetic head slider having a magnetic transducer that performs recording and/or reproducing of magnetic information into/from the magnetic disk,
a support mechanism that supports the magnetic head slider, and
a positioning mechanism that positions the magnetic head slider onto a desired track on the magnetic disk via the support mechanism, characterized in that:
the magnetic head slider has an air bearing surface including surfaces in at least three stages different in height from one another, and
a film for preventing adhesion of organic contaminants and a lubricant is provided on a second stage surface from a side of a surface most proximate to the magnetic disk of the air bearing surface.

16. The magnetic disk drive according to claim 15, characterized by further having:
the film for preventing adhesion of organic contaminants and a lubricant on a surface in a third or later stage from the side of the surface most proximate to the magnetic disk of the air bearing surface.

17. The magnetic disk drive according to claim 15, characterized in that:
the film for preventing adhesion of organic contaminants and a lubricant includes a compound containing fluorine.

18. The magnetic disk drive according to claim 15, characterized by further having:
a mechanism that supplies a lubricant onto the magnetic disk.
